(19) United States
(12) Patent Application Publication
(10) Pub. No.: US 2020/0126065 A1
(43) Pub. Date: Apr. 23, 2020

(54) BLUETOOTH PARKING ACCESS MANAGEMENT

(71) Applicant: FlashParking, Inc., Austin, TX (US)

(72) Inventors: Juan Fabian Rodriguez, Austin, TX (US); Dean Cleaver, Austin, TX (US); Eliseo Joaquin Diaz, Austin, TX (US); Carlos Hernandez, Austin, TX (US)

(73) Assignee: FlashParking, Inc., Austin, TX (US)

(21) Appl. No.: 16/657,700

(22) Filed: Oct. 18, 2019

Related U.S. Application Data
(60) Provisional application No. 62/747,462, filed on Oct. 18, 2018.

(51) Int. Cl. G06Q 20/32; H04W 12/06; H04W 12/00; H04W 4/40; H04W 4/80

(52) U.S. Cl. CPC G06Q 20/3278; H04W 12/06; G06Q 2240/00; H04W 4/40; H04W 4/80; H04W 12/00503

(57) ABSTRACT

A parking facility access management system having a sensing device communicatively connected to the internet and to a mechanism for providing access to a parking facility. A mobile device is communicatively connected to the sensing device while in proximity to the sensing device, and also communicatively connected to the internet while not in proximity to the sensing device. As the mobile device enters proximity to the sensing device, the mobile device communicates exclusively with the sensing device and not the internet. In some embodiments, as the mobile device enters proximity to the sensing device, the mobile device sends a signal to the sensing device to alert the mechanism for providing access to provide access to the parking facility.

### PRIORITY STATEMENT

### Under 35 U.S.C. § 119 & 37 C.F.R. § 1.78

This non-provisional application claims priority based upon prior U.S. Provisional Patent Application Ser. No. 62/747,462 filed Oct. 18, 2018 in the names of Juan Fabian Rodriguez, Dean Alan Cleaver, Eliseo Joaquin Diaz, and Carlos Hernandez entitled “BLUETOOTH PARKING ACCESS MANAGEMENT,” the disclosures of which are incorporated herein in their entirety by reference as if fully set forth herein.

### BACKGROUND OF THE INVENTION

Currently, parking facility operators do not have the ability to seamlessly process customers entering and exiting the parking facility without a parking attendant or an automated parking machine at each entry or exit parking gate. Current methods known for processing a customer entering a parking facility require a customer to stop at a kiosk, roll down their car window, and interact with the system through pulling a ticket or tapping a proximity card, etc. Alternatively, parking facility operators may expend large sums of money to install expensive devices to read toll or similar tags. Depending on the configuration of the parking facility, customers may be required to make a cash or credit card payment. The current process may lead to delays and long queue lines at the gates.

Moreover, many entry and exit kiosks operate by connections to mobile applications through the internet. In such cases, the access mechanisms become inoperable when internet service is unavailable such as in underground facilities, when the weather is a factor, or when internet service is not available.

There is a need, therefore, for a method and system that allows parking operators to automatically process entering and exiting customers, and vend the facility gate, without requiring the customer to manually interact with the kiosk, and with service availability in the absence of internet connectivity.

### SUMMARY OF THE INVENTION

Embodiments of the present invention relate generally to the methods and systems for improved parking facility ingress and egress. More specifically, a parking facility access management system comprises a sensing device communicatively connected to the internet and also to a mechanism for providing access to the facility. A mobile device is communicatively connected to the sensing device while in proximity to the sensing device, and also communicatively connected to the internet.

As the mobile device enters proximity to the sensing device, the mobile device communicates exclusively with the sensing device and not the internet. In some embodiments, as the mobile device enters proximity to the sensing device, the mobile device sends a signal to the sensing device to alert the mechanism for providing access to provide access to the parking facility. In some instances, when the mobile device sends a signal to the sensing device, the sensing device will first confirm the mobile device's credentials and, when confirmed, the sensing device alerts the mechanism for providing access to provide access to the parking facility. In other instances, when the mobile device sends a signal to the sensing device, the sensing device will first confirm receipt of payment and, when confirmed, the sensing device alerts the mechanism for providing access to provide access to the parking facility

The Bluetooth access system of the present invention allows parking facility operators to offer their customers a seamless, touch-free experience. Various embodiments utilize a combination of the sensing device, Bluetooth technology, and mobile devices, which include a vehicle's head unit, to detect customers upon entry and exit of a parking facility, and verify the customer's access credentials without requiring any action on the customer's part at the time of entry or egress. In some embodiments, a credit card on-file will be utilized to collect payment.

The foregoing has outlined rather broadly certain aspects of the present invention in order that the detailed description of the invention that follows may better be understood. Additional features and advantages of the invention will be described hereinafter which form the subject of the claims of the invention. It should be appreciated by those skilled in the art that the conception and specific embodiment disclosed may be readily utilized as a basis for modifying or designing other structures or processes for carrying out the same purposes of the present invention. It should also be realized by those skilled in the art that such equivalent constructions do not depart from the spirit and scope of the invention as set forth in the claims.

### DESCRIPTION OF THE DRAWINGS

For a more complete understanding of the present invention, and the advantages thereof, reference is now made to the following descriptions taken in conjunction with the accompanying drawings, in which:

FIG. 1 is a graphic depiction of the interaction between an application on a mobile device, the sensing device and the cloud in one embodiment of the present invention;

FIG. 2 shows a screenshot of one embodiment of a user interface of an application on a mobile device having iBeacon and Bluetooth capabilities;

FIG. 3 shows a screenshot of one embodiment of a user interface of an application on a mobile device for use in entering and exiting a parking facility; and

FIG. 4 shows an image of one embodiment of the sensing device of the present invention which is located at the entrance and exit of a parking facility and is communicatively connected to an application on a mobile device.

### DESCRIPTION OF THE PREFERRED EMBODIMENTS

The present invention is directed to improved methods and systems for, among other things, parking access management. The configuration and use of the presently preferred embodiments are discussed in detail below. It should be appreciated, however, that the present invention provides many applicable inventive concepts that can be embodied in a wide variety of contexts other than the specific types of parking ingress and egress management described herein. Accordingly, the specific embodiments discussed are merely illustrative of specific ways to make and use the invention, and do not limit the scope of the invention. In addition, the following terms shall have the associated meaning when used herein:

“application” is a software program designed to run on a mobile device;

“cloud” means a collection of logical devices which may or may not include underlying physical servers, wherein all such logical devices may be accessed without any knowledge, or with limited knowledge, of the underlying physical devices, and wherein the collection of logical devices has persistent logical resources, but is non-deterministic in its use of physical resources;

“Eddystone beacon” means Google's Bluetooth low energy proximity sensing device;

“head unit” means a hardware and software interface integrated into a vehicle such as a car or truck that gives the user control over the vehicle's information and entertainment media, such as AM/FM radio, satellite radio, dash cams, GPS navigation, Bluetooth, wifi and the like;

“iBeacon” means Apple Computer's Bluetooth low energy proximity sensing device;

“mobile device” means any portable computing device, typically having a display screen with touch input and/or a miniature keyboard, and includes, without limitation, the head unit;

“parking facility” means an indoor or outdoor area for parking vehicles, including, for example, a parking garage, parking lot, parking ramp, car park and the like; and

“sensing device” means an iBeacon, an Eddystone beacon, or any other similar Bluetooth low energy device that broadcasts its identifier to nearby mobile devices.

In various embodiments of the invention, a user downloads an application onto a mobile device and sets up an account through the application. The registration may include only the name and contact information (e.g., phone number or email address of the user) and may optionally also include information regarding the user's vehicle. In addition, the user may register for all uses or specific uses only, such as, for example, contract parking, transient parking, paying on demand, or transient parking with the ability to make a reservation and pre-pay for parking in advance.

Once the application has been loaded on the mobile device, the device is able to communicate through Bluetooth connectivity with a sensing device located at a parking facility. As a result, the system of the present invention will work even in situations or environments when connectivity through the cloud isn't possible, such as when the sensing device is located in a basement parking facility where cellular service is unavailable.

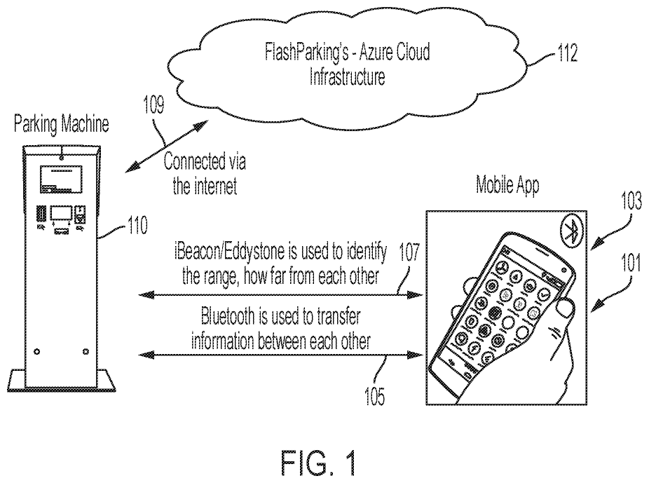

Referring now to FIG. 1, wherein an application 101 is downloaded onto a mobile device 103. The mobile device is communicatively connected to a sensing device. The application 101 transfers information 105 between the mobile device 103 and the sensing device 110. The sensing device 110 identifies the proximity 107 between the sensing device 110 and the mobile device 103. The sensing device 110 is further communicatively connected to the internet 109 for storing and managing information in the cloud 112. Cloud storage service providers include, for example, Amazon Simple Storage Service, Rackspace, Windows Azure, Iron Mountain, and Nirvanix Storage Delivery Network.

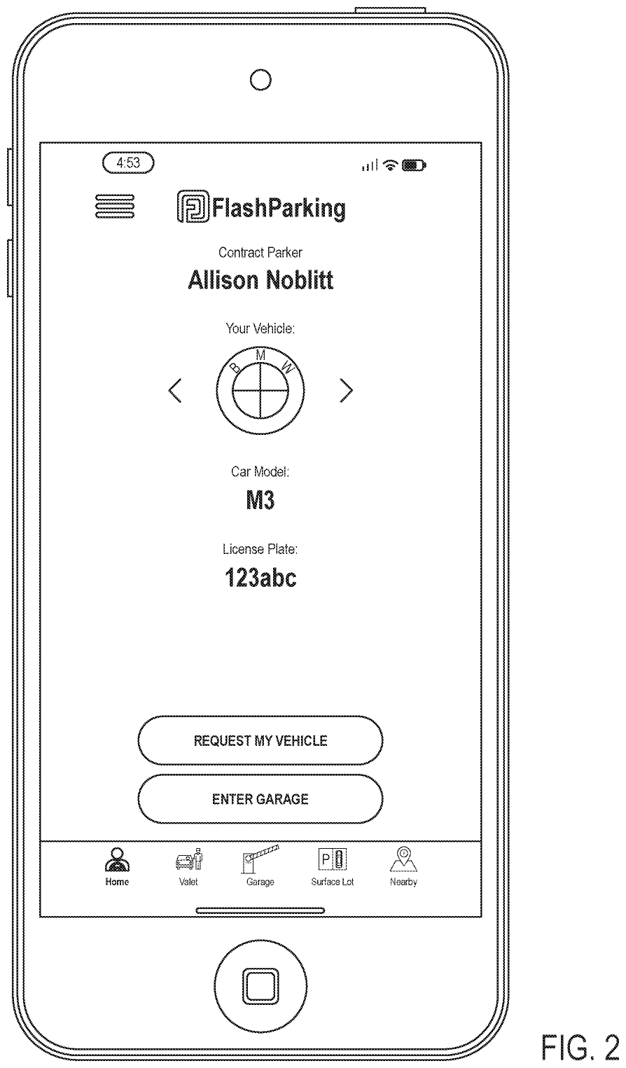

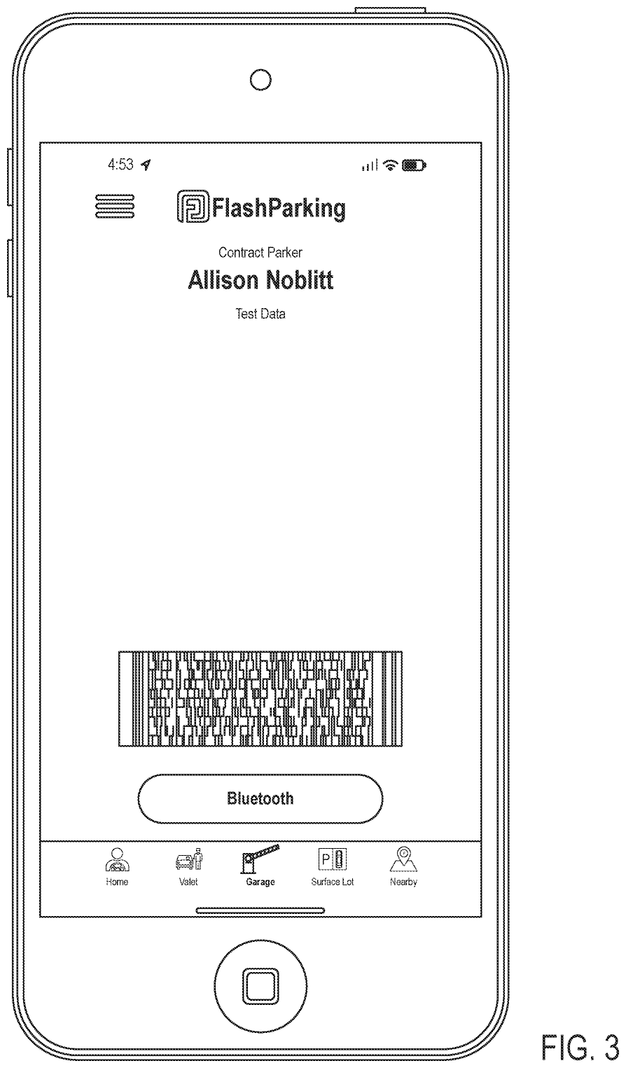

In the application, a user may, for example, find a parking facility, make a reservation at a parking facility, and prepay for a parking session at a parking facility. A screenshot of one embodiment of a user interface of the application of the present invention is shown in FIG. 2. In some instances, a user may select a parking facility connected to the payment system of the present invention, designate a date and time of arrival and departure, and prepay parking fees through the application. In some embodiments, a list of reservations will be displayed through the application. Once the user retrieves that reservation, a button or other icon will be presented in the application which allows the user to enter or exit the parking facility as shown in FIG. 3.

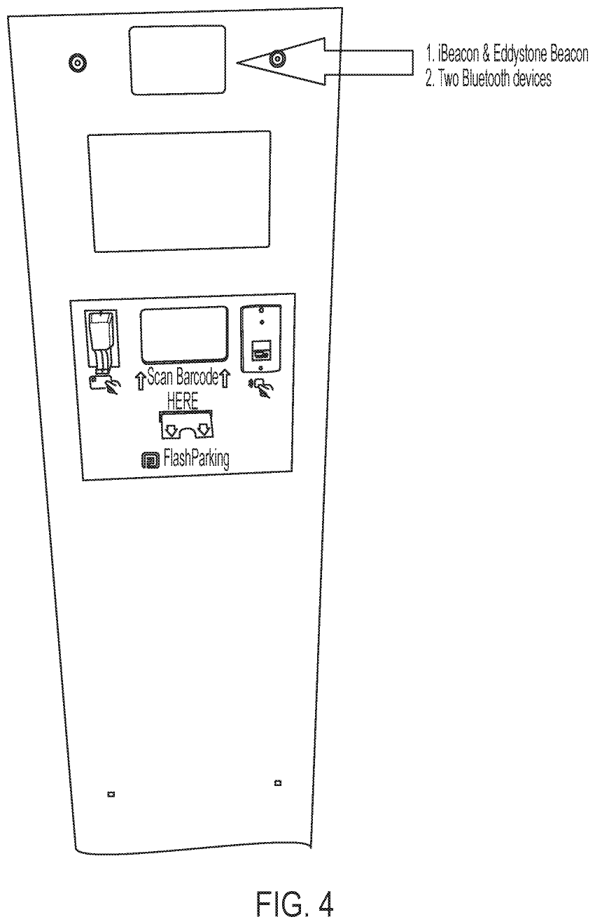

Referring now to FIG. 4 which shows an image of one embodiment of the sensing device of the present invention. A sensing device will be located at each entry and exit lane at a parking facility and, in many instances, the equipment may be combined into a single device and located to operate both an exit and entry lane of the facility. The sensing device is communicatively connected to a mechanism for restricting access to the parking facility, such as an entry/exit gate, and also communicatively connected to the application through the cloud. When a parker approaches a sensing device, the mobile device is authenticated based on credentials stored in the cloud. If multiple registered mobile devices are in proximity to a single sensing device, the application may, for example, provide a notice to each of the users requiring them to designate which application is responsible for making the applicable payment.

In some instances, it may be desirable to include inductive loops at the entry area to ensure the vehicle is near the parking gate prior to vending the gate, thereby preventing the wrong vehicle from trying to enter or exit the parking facility.

Typical sensing devices, such as the iBeacon, broadcast signals through a 360 degrees rotation. However, embodiments of the present invention broadcast signals over a 180 degree or less arc, which provides the ability to confine the devices' detection area to a single parking lane.

In embodiments of the present invention in which an iBeacon is used as the sensing device, the bottom of the device may be located between 46 inches and 62 inches above the ground. In an exemplary embodiment, an iBeacon is mounted with the base located 58 inches above the ground and the detector angled 14.5 degrees downward. Those skilled in the art will appreciate that different mounting heights will require the detector to be positioned at different angles to accommodate the height of the different types of vehicles that may be using the parking facility. Other factors in determining the height of the sensor include the power setting of the broadcast signal of the sensor device and the frequency of the broadcast signal and the frequency in milliseconds.

In some embodiments it may be desirable to add an enclosure around the sensing device, such as a glass or plastic cover, to ensure to directionality of the Bluetooth signal. This ensures that in a parking facility with multiple entry lanes, the signal is only directed to a single lane and there is not overlap of the signal onto adjoining lanes. The power setting on the sensing device may be adjusted to assist in determining the location of the vehicle and whether the vehicle is in the designated lane.

In one embodiment of the present invention is a parking facility access management system comprises a sensing device communicatively connected to the internet and to a mechanism for providing access to a parking facility; a mobile device communicatively connected to the sensing device while in proximity to the sensing device, and communicatively connected to the internet while not in proximity to the sensing device; wherein as the mobile device enters proximity to the sensing device, the mobile device communicates exclusively with the sensing device and not the internet. In some embodiments, as the mobile device enters proximity to the sensing device, the mobile device sends a signal to the sensing device to alert the mechanism for providing access to provide access to the parking facility. Alternatively, as the mobile device enters proximity to the sensing device, the mobile device sends a signal to the sensing device and, if the sensing device can confirm the mobile device's credentials, the sensing device alerts the mechanism for providing access to provide access to the parking facility, or, as the mobile device enters proximity to the sensing device, the mobile device sends a signal to the sensing device and, if the sensing device receives payment information from the mobile device, the sensing device alerts the mechanism for providing access to provide access to the parking facility.

Various embodiments of the parking system of the present invention may be manifested in a variety of configurations. Several specific examples, which should not be considered limiting, follow below.

### Example 1: Bluetooth Access for Contract Parkers

In one embodiment, the parking system of the present invention may be configured to provide a nonstop entering and exiting experience for a registered contract parker. The contract parker downloads the application onto his or her mobile device. They would then provide registration information through the application, and the registration information would include information regarding the parking facility designated by the contract parker and the terms of the contract governing the agreed-upon arrangement for parking.

When the contract parker arrives at the entry gate of the designated parking facility during the contract term, the sensing device communicates with the mobile device through Bluetooth to determine the proximity of the mobile device to the sensing device. The sensing device then communicates through the internet to the cloud to verify, using the registration information and the terms of the contract, the contract parker's right to access the facility. Upon verification, the sensing device will open the gate to allow the contract parker access to the parking facility.

### Example 2: Bluetooth Access for Transient Parkers with a Prepaid Reservation

In another embodiment of the present invention, the parking system of the present invention may be configured to provide a nonstop entering and exiting experience for a transient parker on a prepaid basis. The transient parker downloads the application onto his or her mobile device. They would then provide registration information through the application, and the registration information would include information regarding the parking facilities available for parking by the transient parker and would also include the ability to pre-pay for parking at the available facilities.

When the transient parker arrives at the entry gate of one of the available parking facilities, the sensing device communicates with the mobile device through Bluetooth to determine the proximity of the mobile device to the sensing device. The sensing device then communicates through the internet to the cloud to verify, using the registration information, the transient parker's right to access the facility. Upon verification, the sensing device will open the gate to allow the transient parker access to the parking facility. When the transient parker leaves the parking facility, the sensing device communicates through the internet to the cloud to provide information regarding the parking fees owed by the transient parker, and that amount is debited from his or her prepaid account.

### Example 3: Bluetooth Access for Transient Parkers

In yet another embodiment of the present invention, the parking system of the present invention may be configured to provide a nonstop entering and exiting experience for a transient parker who is charged at the time of use. Once again, the transient parker downloads the application onto his or her mobile device. They would then provide registration information through the application, and the registration information would include information regarding the parking facilities available for parking by the transient parker and would also include credit card, debit card, PayPal or another payment method to be used to pay parking fees.

When the transient parker arrives at the entry gate of one of the available parking facilities, the sensing device communicates with the mobile device through Bluetooth to determine the proximity of the mobile device to the sensing device. The sensing device then communicates through the internet to the cloud to verify, using the registration information, the transient parker's right to access the facility. Upon verification, the sensing device will open the gate to allow the transient parker access to the parking facility. When the transient parker leaves the parking facility, the sensing device communicates through the internet to the cloud to provide information regarding the parking fees owed by the transient parker, and that amount is paid using the payment method designated by the parker.

Those skilled in the art will appreciate the numerous features and advantages offered by the various embodiments of the present invention. For example, once the parker has registered through the application, they can quickly and easily access a parking facility without pairing the Bluetooth to the sensing device. Also, importantly, because the mobile device is connected by Bluetooth to the sensing device, the mobile device does not need access to a cellular carrier or internet for the entry or exit transaction to take place. This allows for the use of the parking system of the present invention in remote areas or underground areas where cellular service and internet service are spotty or unavailable.

From the parking facility's perspective, one significant benefit is that each sensing device may be individually adjusted to provide optimal performance in each lane. Also, there is no need for an expensive toll tag reader for each lane and no need for active or passive tags. Therefore, the cost of implementation is minimal compare to all of the hardware and tags that are needed with systems that are commonly available today.

The present invention is directed to improved methods and systems for, among other things, parking systems. The configuration and use of the presently preferred embodiments are discussed in detail below. It should be appreciated, however, that the present invention provides many applicable inventive concepts that can be embodied in a wide variety of contexts other than parking systems. Accordingly, the specific embodiments discussed are merely illustrative of specific ways to make and use the invention, and do not limit the scope of the invention. In addition, the following terms shall have the associated meaning when used herein:

While the present system and method has been disclosed according to the preferred embodiment of the invention, those of ordinary skill in the art will understand that other embodiments have also been enabled. Even though the foregoing discussion has focused on particular embodiments, it is understood that other configurations are contemplated. In particular, even though the expressions “in one embodiment” or “in another embodiment” are used herein, these phrases are meant to generally reference embodiment possibilities and are not intended to limit the invention to those particular embodiment configurations. These terms may reference the same or different embodiments, and unless indicated otherwise, are combinable into aggregate embodiments. The terms “a”, “an” and “the” mean “one or more” unless expressly specified otherwise. The term “connected” means “communicatively connected” unless otherwise defined.

When a single embodiment is described herein, it will be readily apparent that more than one embodiment may be used in place of a single embodiment. Similarly, where more than one embodiment is described herein, it will be readily apparent that a single embodiment may be substituted for that one device.

In light of the wide variety of parking systems known in the art, the detailed embodiments are intended to be illustrative only and should not be taken as limiting the scope of the invention. Rather, what is claimed as the invention is all such modifications as may come within the spirit and scope of the following claims and equivalents thereto.

None of the description in this specification should be read as implying that any particular element, step or function is an essential element which must be included in the claim scope. The scope of the patented subject matter is defined only by the allowed claims and their equivalents. Unless explicitly recited, other aspects of the present invention as described in this specification do not limit the scope of the claims.

To aid the Patent Office and any readers of any patent issued on this application in interpreting the claims appended hereto, the applicant wishes to note that it does not intend any of the appended claims or claim elements to invoke 35 U.S.C. 112(f) unless the words “means for” or “step for” are explicitly used in the particular claim.

We claim:

1. A parking facility access management system, comprising:
a sensing device communicatively connected to the internet and to a mechanism for providing access to a parking facility;
a mobile device communicatively connected to the sensing device while in proximity to the sensing device, and communicatively connected to the internet while not in proximity to the sensing device;
wherein as the mobile device enters proximity to the sensing device, the mobile device communicates exclusively with the sensing device and not the internet.

2. The parking facility access management system of claim 1, wherein as the mobile device enters proximity to the sensing device, the mobile device sends a signal to the sensing device to alert the mechanism for providing access to provide access to the parking facility.

3. The parking facility access management system of claim 1, wherein as the mobile device enters proximity to the sensing device, the mobile device sends a signal to the sensing device and, if the sensing device can confirm the mobile device's credentials, the sensing device alerts the mechanism for providing access to provide access to the parking facility.

4. The parking facility access management system of claim 1, wherein as the mobile device enters proximity to the sensing device, the mobile device sends a signal to the sensing device and, if the sensing device receives payment information from the mobile device, the sensing device alerts the mechanism for providing access to provide access to the parking facility.

5. The parking facility access management system of claim 1, wherein the sensing device is enclosed in an enclosure that limits directionality of the sensing device to a single lane.

6. The parking facility access management system of claim 1, wherein the sensing device is an Eddystone beacon.

7. The parking facility access management system of claim 1, wherein the sensing device is an iBeacon.

8. The parking facility access management system of claim 1, wherein the sensing device is located between 46 and 62 inches above the ground and angled approximately 14.5 degrees downward.

9. The parking facility access management system of claim 1, wherein the mechanism for providing access to the parking facility is an access gate.

10. The parking facility access management system of claim 1, wherein the mobile device is an automobile head unit.

11. The parking facility access management system of claim 1, wherein the mobile device is a mobile phone.

12. The parking facility access management system of claim 1, wherein an application on the mobile device is used to communicate between the mobile device and the sensing device.

13. The parking facility access management system of claim 1, wherein an application on the mobile device is used to communicate between the mobile device and the sensing device.

14. The parking facility access management system of claim 1, wherein the mobile device communicates with the sensing device when the mobile device is unable to connect to the internet.
